(19) United States
(12) Patent Application Publication
(10) Pub. No.: US 2014/0022196 A1
(43) Pub. Date: Jan. 23, 2014

(54) REGION OF INTEREST OF AN IMAGE

(71) Applicants: Shaun Henry, Middleton, ID (US); Greg Creager, Nampa, ID (US); Nathan Mcintyre, Meridian, ID (US)

(72) Inventors: Shaun Henry, Middleton, ID (US); Greg Creager, Nampa, ID (US); Nathan Mcintyre, Meridian, ID (US)

(73) Assignee: HEWLETT-PACKARD DEVELOPMENT COMPANY, L.P., Fort Collins, CO (US)

(21) Appl. No.: 14/009,374

(22) PCT Filed: May 24, 2011
(86) PCT No.: PCT/US11/37822

§ 371 Date: Oct. 2, 2013

(51) Int. Cl. G06K 9/20

(52) U.S. Cl. CPC G06K 9/2081
USPC 345/173

(57) ABSTRACT

A device to detect a user accessing a region of interest of an image, access pixels of the region of interest to identify alphanumeric characters within the region of interest, and store the alphanumeric characters and a location of the alphanumeric characters within metadata of the image.

### BACKGROUND

If a user would like to include comments with an image and/or edit the image, the user can view the image on a display component and use an input component to manually enter comments or make edits to the image. The edits can include modifying a name of the image and/or listing where the image was taken. Additionally, the comments can include information of what is included in the image, such as any words which are displayed within the image and who is included in the image.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device with a display component according to an embodiment.

FIG. 2A illustrates a user accessing an image displayed on a display component according to an embodiment.

FIG. 2B illustrates an image accessible to a device according to an embodiment.

FIG. 3 illustrates a block diagram of an image application accessing pixels of a region of interest according to an embodiment.

FIG. 4A and FIG. 4B illustrate block diagrams of alphanumeric characters being stored within metadata of an image according to embodiments.

FIG. 5 illustrates an image application on a device and the image application stored on a removable medium being accessed by the device according to an embodiment.

FIG. 6 is a flow chart illustrating a method for managing an image according to an embodiment.

FIG. 7 is a flow chart illustrating a method for managing an image according to an embodiment.

### DETAILED DESCRIPTION

An image can be rendered or displayed on a display component and a sensor can detect for a user accession a location of the display component. In one embodiment, the user can access the display component by touching or swiping across one or more locations of the display component. By detecting the user accessing the location of the display component, a device can identify a corresponding location of the image as a region of interest of the image being accessed by the user.

In response to identifying the location of the region of interest on the image, the device can access pixels of the image within the region of interest to identify alphanumeric characters within the region of interest. In one embodiment, the device can apply an object character recognition process to the pixels to identify the alphanumeric characters. In response to identifying any alphanumeric characters within the region of interest, the device can store the alphanumeric characters and/or a location of the alphanumeric characters within metadata of the image.

By identifying and storing the alphanumeric characters and/or the location of the alphanumeric characters, a user friendly experience can be created for the user by detecting information of the image relevant to the user and storing the relevant information within the metadata of the image in response to the user accessing the region of interest of the image. Additionally, the information within the metadata can be used to sort and archive the image.

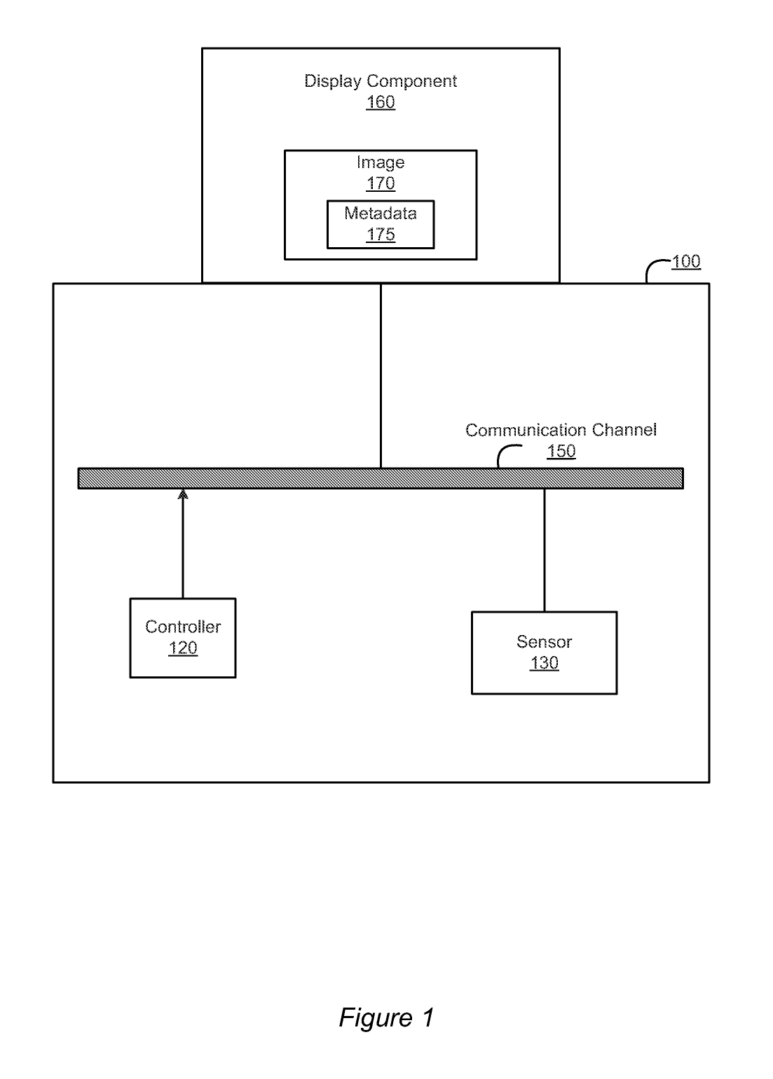

FIG. 1 illustrates a device 100 with a display component 160 according to an embodiment. In one embodiment, the device 100 can be a cellular device, a PDA (Personal Digital Assistant), an E (Electronic)—Reader, a tablet, a camera, and/or the like. In another embodiment, the device 100 can be a desktop, a laptop, a notebook, a tablet, a netbook, an all-in-one system, a server, and/or any additional device which can be coupled to a display component 160.

As illustrated in FIG. 1, the device 100 includes a controller 120, a display component 160, a sensor 130, and a communication channel 150 for the device 100 and/or one or more components of the device 100 to communicate with one another. In one embodiment, the device 100 includes an image application stored on a computer readable medium included in or accessible to the device 100. In other embodiments, the device 100 includes additional components and/or is coupled to additional components in addition to and/or in lieu of those noted above and illustrated in FIG. 1.

As noted above, the device 100 can include a controller 120. The controller 120 can send data and/or instructions to the components of the device 100, such as the display component 160, the sensor 130, and/or the image application. Additionally, the controller 120 can receive data and/or instructions from components of the device 100, such as the display component 160, the sensor 130, and/or the image application.

The image application is an application which can be utilized in conjunction with the controller 120 to manage an image 170. The image 170 can be a two dimensional and/or a three dimensional digital image accessible by the controller 120 and/or the image application. When managing an image 170, the controller 120 and/or the image application can initially display the image 170 on a display component 160 of the device 100. The display component 160 is a hardware component of the device 100 configured to output and/or render the image 170 for display.

In response to the image 170 being displayed on the display component 160, the controller 120 and/or the image application can detect for a user accessing a region of interest of the image 170 using a sensor 130. For the purpose this application, the sensor 130 is a hardware component of the device 100 configured to detect a location of the display component 160 the user is accessing. The user can be any person which can use a finger, hand, and/or pointing device to touch or swipe across one or more locations of the display component 160 when accessing a region of interest of the image 170.

The controller 120 and/or the image application can identify a location of the image corresponding to the accessed location of the display component as a region of interest of the image 170. For the purposes of this application, a region of interest corresponds to a location or area of the image 170 the user is accessing. In response to detecting the user accessing the region of interest, the controller 120 and/or the image application can access pixels of the image 170 included within the region of interest.

The controller 120 and/or the image application can then identify one or more alphanumeric characters within the region of interest. The alphanumeric characters can include numbers, characters, and/or symbols. In one embodiment, the controller 120 and/or the image application apply an object character recognition process or algorithm to the pixels included within the region of interest to identify the alphanumeric characters.

In response to identifying one or more alphanumeric characters within the region of interest of the image 170, the controller 120 and/or the image application can store the identified alphanumeric characters and a location of the alphanumeric characters within metadata 175 of the image 170. The metadata 175 can be a portion of the image 170 which can store data and/or information of the image 170. In another embodiment, the metadata 175 can be another file associated with the image 175.

The image application can be firmware which is embedded onto the controller 120, the device 100, and/or a storage device coupled to the device 100. In another embodiment, the image application is an application stored on the device 100 within ROM (read only memory) or on the storage device accessible by the device 100. In other embodiments, the image application is stored on a computer readable medium readable and accessible by the device 100 or the storage device from a different location. The computer readable medium can include a transitory or a non-transitory memory.

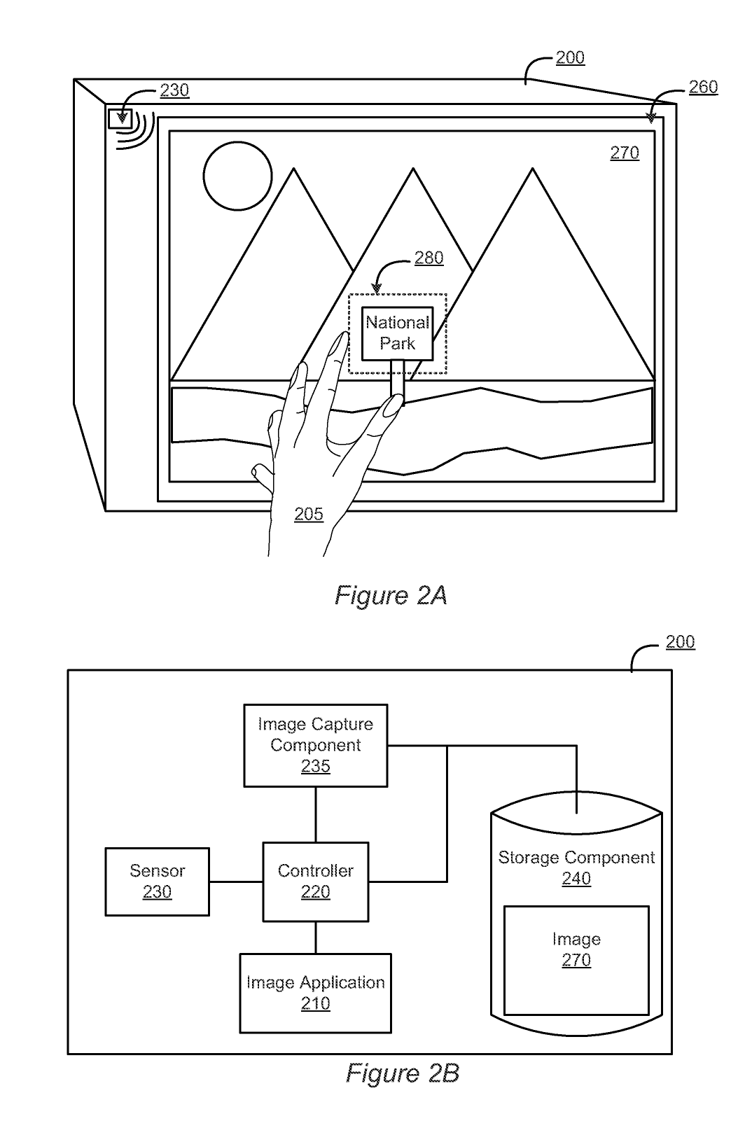

FIG. 2A illustrates a user 205 accessing an image 270 displayed on a display component 260 according to an embodiment. As noted above, the display component 260 is a hardware output component configured to display one or more images 270 at one or more locations of the display component 260. The controller and/or the image application can keep track of where on the display component 260 an image 270 is being displayed. In one embodiment, the controller and/or the image application can create a bitmap and/or a pixel map of the display component 260 to identify where the image 270 is displayed.

The display component 260 can be integrated as part of the device 200 or the display component 260 can be coupled to the device 200. In one embodiment, the display component 260 can include a LCD (liquid crystal display), a LED (light emitting diode) display, a CRT (cathode ray tube) display, a plasma display, a projector, a touch wall and/or any additional device configured to output or render one or more images 270.

An image 270 can be a digital image of one or more people, structures, objects, and/or scenes. Additionally, as shown in FIG. 2A, the image 270 can include text, displayed as alphanumeric characters on a sign, a structure, an object, and/or on apparel worn by a person within the image 270. The alphanumeric characters can include one or more numbers, characters, and/or symbols.

In response to the display component 260 displaying an image 270, the controller and/or the image application can detect a user 205 accessing a region of interest 280 of the image 270 using a sensor 230 of the device 200. As noted above, the user 205 can be any person which can access a region of interest 280 on the image 205 by touching a location of the display component 260 and/or by swiping across the location of the display component 260. The user 205 can access the display component 260 with a finger, a hand, and/or using a pointing device. The pointing device can include a stylus and/or pointer.

The sensor 230 is a hardware component of the device 200 configured to detect where on the display component 260 the user 205 is accessing. In one embodiment, the sensor 230 can be an image capture component, a proximity sensor, a motion sensor, a stereo sensor and/or an infra-red device. The image capture component can be a three dimensional depth image capture device. In another embodiment, the sensor 230 can be a touch panel coupled to the display component 260. In other embodiments, the sensor 230 can include any additional device configured to detect the user 205 accessing one or more locations on the display component 260.

The sensor 230 can notify the controller and/or the image application 210 of where on the display component 260 the user 205 is detected to be accessing. The controller and/or the image application can then compare the accessed locations of the display component 260 to previously identified locations of where on the display component 260 the image 270 is being displayed. If the accessed location of the display component 260 overlaps a location of where the image 270 is being displayed, the overlapping location will be identified by the controller and/or the image application as a region of interest 280 of the image 270.

As shown in FIG. 2A, the region of interest 280 is a location of the image 270 which the user 205 is accessing. In one embodiment, an outline of the region of interest 280 can be displayed at the accessed location of the display component 260 in response to the sensor 230 detecting the user 205 accessing the corresponding location. The region of interest 280 can include predefined dimensions and/or a predefined size. In another embodiment, dimensions and/or a size of the region of interest 280 can be defined by the user 205, the controller, and/or by the image application.

Additionally, the dimensions and/or the size of the region of interest 280 can be modified by the user 205. In one embodiment, the user 205 can modify the dimensions and/or the size of the region of interest 280 by touching a corner point or edge of the outline of the region of interest 280 and proceeding to move the corner point or edge inward to decrease the dimensions and/or size of the region of interest 280. In another embodiment, the user 205 can increase the size of the region of interest 280 by touching a corner point or edge of the outline of the region of interest 280 and moving the corner point or edge outward.

FIG. 2B illustrates an image 270 accessible to a device 200 according to an embodiment. As shown in FIG. 2A, one or more images 270 can be stored on a storage component 240. The storage component 240 can be a hard drive, a compact disc, a digital versatile disc, a Blu-ray disk, a flash drive, a network attached storage device, and/or any additional non-transitory computer readable memory accessible to the controller 220 and/or the image application 210 and configured to store an image 270 and/or metadata 275 of the image 270. In other embodiments, the storage component 240 can be stored on another device accessible to the controller 220 and/or the image application 210 through a network interface component.

Additionally, as shown in the present embodiment, the device 200 can include an image capture component 235. The image capture component 235 is a hardware component of the device 200 configured by a user, the controller 220, and/or the image application 210 to capture one or more images 270 for the device 200. In one embodiment, the image capture component 235 can be a camera, a scanner, and/or photo sensor of the device 200.

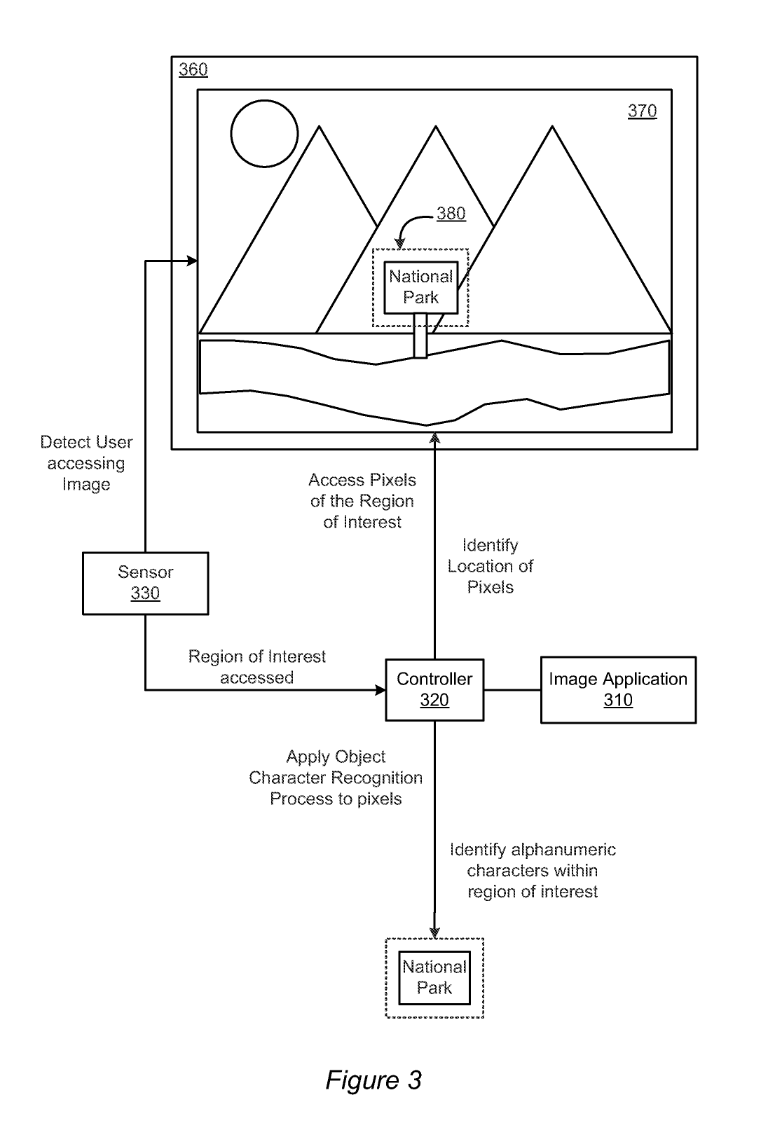

FIG. 3 illustrates a block diagram of an image application 310 accessing pixels of an image 370 included within a region of interest 380 to identify alphanumeric characters according to an embodiment. As shown in FIG. 3, the sensor 330 has detected a user accessing a location of a display component 360 rendering the image 370. The sensor 330 proceeds to identify the location of the display component 360 being accessed and notifies the controller 320 and/or the image application 310 of the accessed location.

The controller 320 and/or the image application 310 compare the accessed location to a previously identified location of where on the display component 360 the image 370 is being displayed. By comparing the accessed location to where the image 370 is being displayed, the controller 320 and/or the image application 310 can identify where the region of interest 380 is on the image 370.

In response to identifying the region of interest 380 on the image 370, the controller 320 and/or the image application 310 can proceed to access pixels of the image 370 which are included within the location of the region of interest 380. In one embodiment, the controller 320 and/or the image application 310 additionally record the location of the pixels included within the region of interest 380. The location of the pixels can be recorded by the controller 320 and/or the image application 310 as a coordinate. The coordinate can correspond to a location on the image 370 and/or a location on the display component 360.

The controller 320 and/or the image application 310 proceed to identify alphanumeric characters within the region of interest 380 of the image 370. In one embodiment, the controller 320 and/or the image application can apply an object character recognition process or algorithm to the pixels of the image 370 within the region of interest 380 to identify any alphanumeric characters within the region of interest 380. Applying the object character recognition process can include the controller 320 and/or the image application 310 detecting a pattern of the pixels within the region of interest 380 to determine whether they match any font. The controller 320 and/or the image application 310 can then identify corresponding alphanumeric characters which match the pattern of the pixels.

In another embodiment, the controller 320 and/or the image application 310 can additionally apply a fill detection process or algorithm to the pixels within the region of interest 380. The fill detection process can be used by the controller 320 and/or the image application 310 to identify outlines or boundaries of any alphanumeric characters believed to be within the region of interest 380. The controller 320 and/or the image application 310 can determine whether the identified outline or boundaries match the pixels to identify whether the pixels within the region of interest 380 match alphanumeric characters and to identify the location of the alphanumeric characters.

In other embodiments, the controller 320 and/or the image application 310 can prompt the user to identify a color of the alphanumeric characters within the region of interest 380. By identifying the color of the alphanumeric characters, the controller 320 and/or the image application 310 can focus on the identified color and ignore other colors, As a result, the controller 320 and/or the image application 310 can more accurately identify any alphanumeric characters from the pixels within the region of interest 380. In other embodiments, additional processes and/or algorithms can be applied to the pixels of the image 370 within the region of interest to identify the alphanumeric characters.

In response to identifying the alphanumeric characters, the controller 320 and/or the image application 310 can proceed to identify a location of the alphanumeric characters. In one embodiment, the controller 320 and/or the image application 310 can identify the location of the alphanumeric characters as the location of the region of interest 380 on the image 370. In another embodiment, the controller 320 and/or the image application 310 can identify the location of the alphanumeric characters as the location of the pixels which make up the alphanumeric characters.

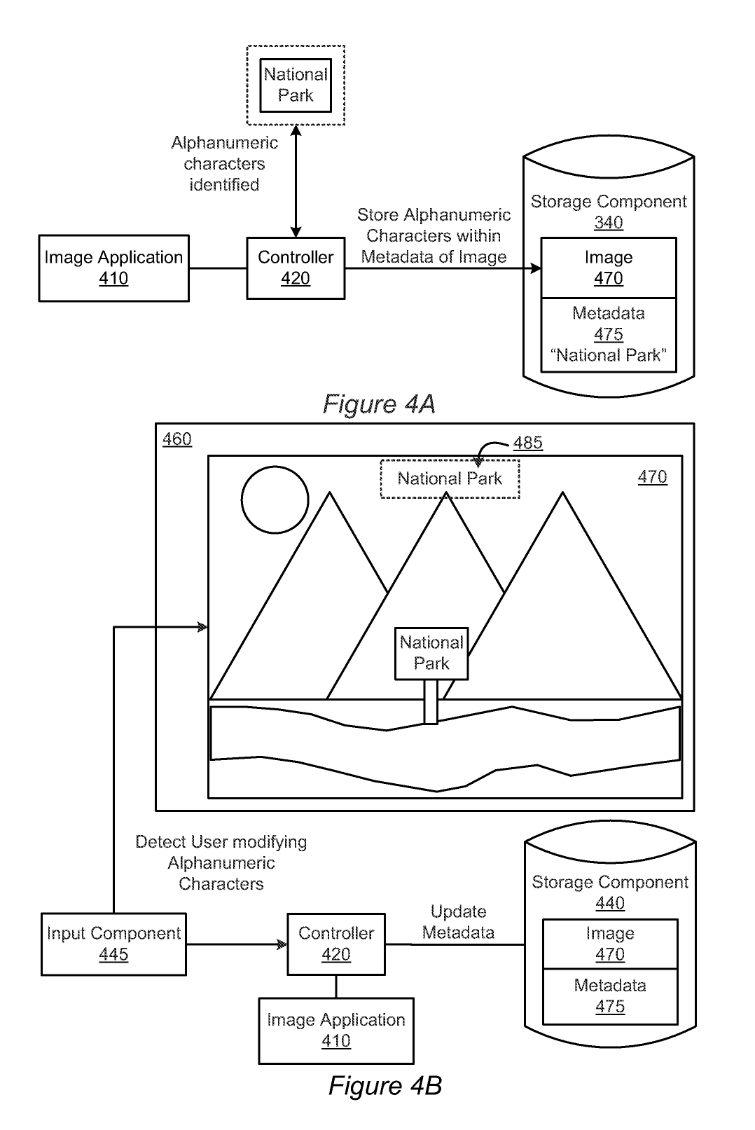

FIG. 4A and FIG. 4B illustrate block diagrams of an image application storing alphanumeric characters within metadata of an image according to embodiments. As shown in FIG. 4A, the controller 420 and/or the image application 410 have identified that the region of interest includes the alphanumeric characters “National Park.”

In response to identifying the alphanumeric characters, the controller 420 and/or the image application 410 proceed to store the alphanumeric characters within metadata 475 of the image 470. As noted above, the image 470 can include corresponding metadata 475 to store data or information of the age 470. In one embodiment, the metadata 475 can be included as part of the image 470. In another embodiment, the metadata 475 can be stored as another file associated with the image 470 on a storage component 440.

Additionally, the controller 420 and/or the image application 410 can store the location of the alphanumeric characters within the metadata 475 of the image 470. In one embodiment, the location of the alphanumeric characters can be stored as one or more coordinates corresponding to a location on a pixel map or a bit map. The coordinates can correspond to a location of the region of interest on the image 470 or the coordinates can correspond to a location of the pixels which make up the alphanumeric characters.

In one embodiment, as illustrated in FIG. 4B, the controller 420 and/or the image application 410 can additionally render the identified alphanumeric characters 485 for display on the display component 460. As shown in the present embodiment, the identified alphanumeric characters 485 can be rendered as a layer overlapping the image 470. By rendering the alphanumeric characters 485 for display, the user can determine whether the identified alphanumeric characters 485 being stored on the metadata 475 is accurate.

In another embodiment, the controller 420 and/or the image application 410 can further render the identified alphanumeric characters 485 at the location of the pixels of the alphanumeric characters within the region of interest. By rendering the identified alphanumeric characters 485 at the location of the pixels of the alphanumeric characters, the user can determine whether the coordinate or the location of the pixels stored within the metadata 475 is accurate.

Additionally, the user can make modifications or edits to the identified alphanumeric characters 485 and/or to the location of the identified alphanumeric characters 475 stored within the metadata 475. An input component 445 of the device can detect for the user making modifications and/or edits to the identified alphanumeric characters 485 and/or to the location of the identified alphanumeric characters 485.

The input component 445 is a component of the device configured to detect the user making one or more modifications or updates to the metadata 475. In one embodiment, the input component 445 can include one or more buttons, a keyboard, a directional pad, a touchpad, a touch screen and/or a microphone. In another embodiment, the sensor and/or the image capture component of the device can operate as the input component 445.

In response to the user making modifications or edits to the identified alphanumeric characters 485 and/or the location of the identified alphanumeric characters 485, the controller 420 and/or the image application 410 can proceed to update or overwrite the metadata 475 of the image 470 with the modifications,

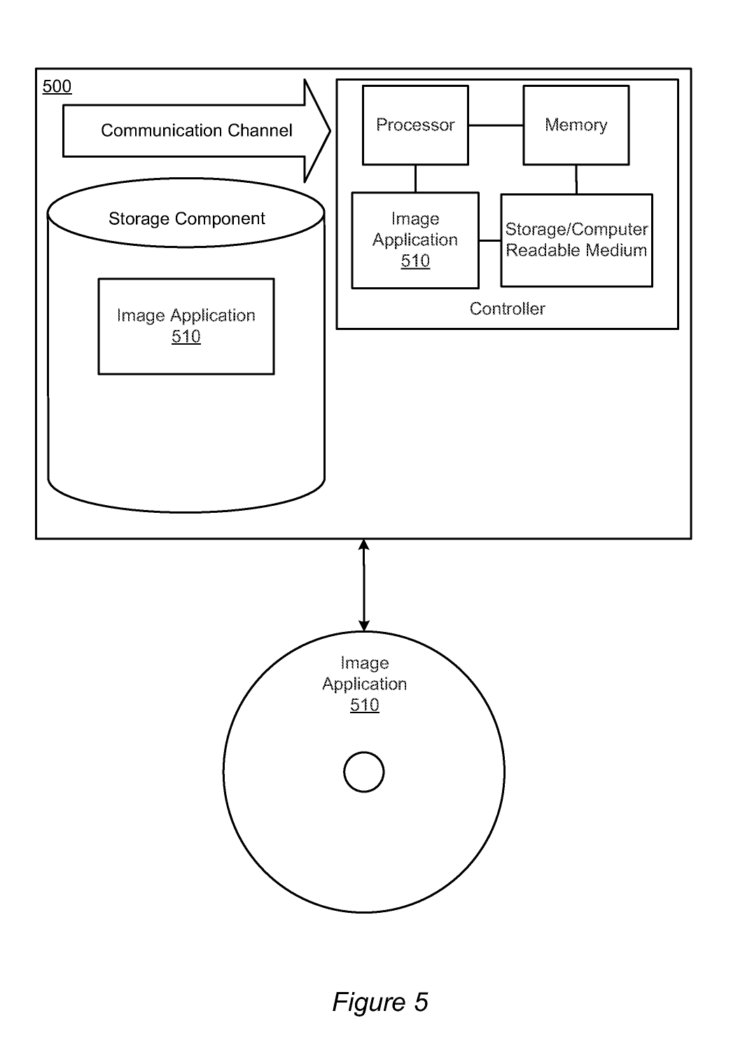

FIG. 5 illustrates an image application 510 on a device 500 and the image application 510 stored on a removable medium being accessed by the device 500 according to an embodiment. For the purposes of this description, a removable medium is any tangible apparatus that contains, stores, communicates, or transports the application for use by or in connection with the device 500. As noted above, in one embodiment, the image application 510 is firmware that is embedded into one or more components of the device 500 as ROM. In other embodiments, the image application 510 is an application which is stored and accessed from a hard drive, a compact disc, a flash disk, a network drive or any other form of computer readable medium that is coupled to the device 500.

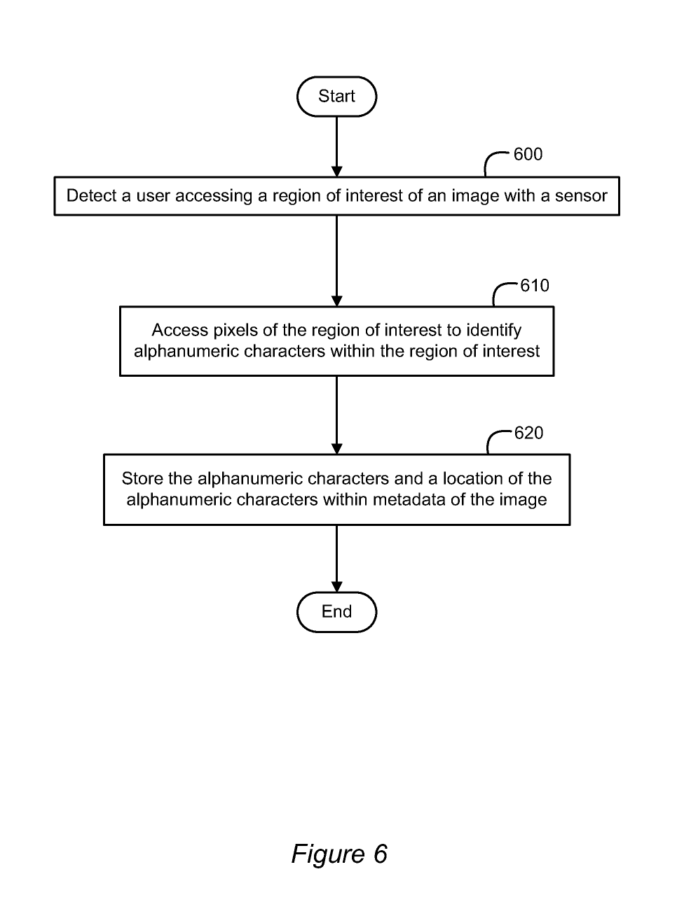

FIG. 6 is a flow chart illustrating a method for managing an image according to an embodiment. The method of FIG. 6 uses a device with a controller, a display component, a sensor, an image, and/or an image application. In other embodiments, the method of FIG. 6 uses additional components and/or devices in addition to and/or in lieu of those noted above and illustrated in FIGS. 1, 2, 3, 4, and 5.

As noted above, the image application is an application which can be utilized independently and/or in conjunction with the controller to manage an image. The image can be a two dimensional and/or a three dimensional image which the controller and/or the image application can access from a storage component. The storage component can be locally included with the device or remotely accessed from another location.

When managing the image, the controller and/or the image application can initially render the image for display on a display component of the device. The controller and/or the image application can identify where on the display component the image is being rendered or displayed. A sensor can then detect a user accessing one or more locations of the display component for the controller and/or the image application to identify a region of interest on the image at 600. In one embodiment, the sensor is coupled to or integrated as part of the display component as a touch screen. The sensor can notify the controller and/or the image application of the location on the display component accessed by the user.

By comparing the detected location of the display component with the previously identified location of where on the display component the image is being display, the controller and/or the image application can identify the location of the region of interest on the image. In response to identifying the region of interest on the image, the controller and/or the image application can access pixels of the image within the region of interest to identify alphanumeric characters within the region of interest at 610.

As noted above, the controller and/or the image application can apply an object character recognition process or algorithm to the pixels of the image within the region of interest to identify the alphanumeric characters. In another embodiment, the user can be prompted for a color of the alphanumeric characters for the controller and/or the image application to ignore other colors not selected by the user when identifying the alphanumeric characters.

Once the alphanumeric characters have been identified, the controller and/or the image application can identify a location of the alphanumeric characters within the image. In one embodiment, the location can be a coordinate of the region of interest and/or a location of the pixels which make up the alphanumeric characters. The controller and/or the image application can then store the alphanumeric characters and the location of the alphanumeric characters within metadata of the image at 620. The method is then complete. In other embodiments, the method of FIG. 6 includes additional steps in addition to and/or in lieu of those depicted in FIG. 6.

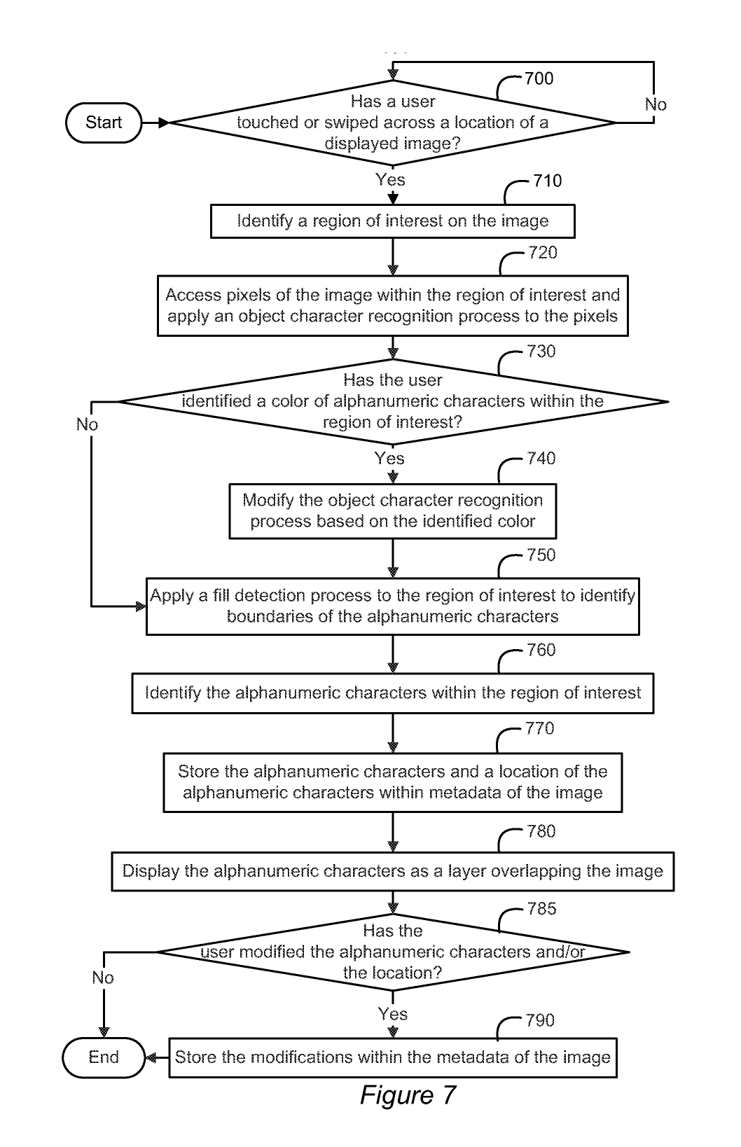

FIG. 7 is a flow chart illustrating a method for managing an image according to another embodiment. Similar to the method disclosed above, the method of FIG. 7 uses a device with a controller, a display component, a sensor, an image, and/or an image application. In other embodiments, the method of FIG. 7 uses additional components and/or devices in addition to and/or in lieu of those noted above and illustrated in FIGS. 1, 2, 3, 4, and 5.

As noted above, an image can initially be rendered for display on a display component. Additionally, the controller and/or the image application can identify where on the display component, the image is being displayed. A sensor can then detect for a location of the display component a user is accessing. The sensor can determine whether a user has touched or swiped across a location of the image displayed by the display component at 700. If the user has not accessed the display component, the sensor can continue to detect for the user accessing the display component at 700.

If the user has accessed a location of the display component, the sensor can pass the accessed location to the controller and/or the image application. The controller and/or the image application can then proceed to compare the accessed location to where on the display component the image is being displayed, to identify a region of interest on the image at 710. The controller and/or the image application can then access pixels of the image included within the region of interest and proceed to apply an object character recognition process to the pixels at 720.

In one embodiment, the controller and/or the image application can additionally determine whether the user has identified a color of the alphanumeric characters within the region of interest at 730. If a color has been selected or identified by the user, the controller and/or the image application can modify the object character recognition process based on the identified color to detect alpha numeric characters of the identified color at 740. Additionally, the controller and/or the image application can apply a fill detection process to pixels of the image within the region of interest to identify the boundaries of the alphanumeric characters at 750.

In another embodiment, if no color was identified by the user, the controller and/or the image application can skip modifying the object character recognition process and proceed to apply the fill detection process to identify the boundaries of the alphanumeric characters at 750. The controller and/or the image application can then identify alphanumeric characters returned from the object character recognition process and/or the fill detection process at 760. In response to identifying the alphanumeric characters, the controller and/or the image application can store the alphanumeric characters and the location of the alphanumeric characters within the metadata of the image at 770.

As noted above, the metadata can be a portion or segment of the image configured to store data and/or information of the image. In another embodiment, the metadata can be stored on another filed associate with the image. The controller and/or the image application can additionally render the alphanumeric characters on the display component as a layer overlapping the image at 780. In one embodiment, the overlapping layer of the alphanumeric characters can be displayed at the location of the pixels which make up the alphanumeric characters.

As a result, the user can verify whether the alphanumeric characters stored within the metadata is accurate and the user can verify the location of the alphanumeric characters. Additionally, an input component can detect for the user modifying the alphanumeric characters and/or the location of the alphanumeric characters at 785. If no changes are detected by the user, the method can then be complete. In other embodiments, if the user is detected to make any changes, the controller and/or the image application can update the alphanumeric characters and/or the location of the alphanumeric characters within the metadata of the image at 790. The method is then complete. In other embodiments, the method of FIG. 7 includes additional steps in addition to and/or in lieu of those depicted in FIG. 7.

What is claimed is:

1. A method for managing an image comprising:
detecting a user accessing a region of interest of an image with a sensor;
accessing pixels of the region of interest to identify alphanumeric characters within the region of interest; and
storing the alphanumeric characters and a location of the alphanumeric characters within metadata of the image.

2. The method for managing an image of claim 1 wherein detecting the user accessing a region of interest includes detecting the user touching or swiping across a location of the image displayed on a display component.

3. The method for managing an image of claim 1 wherein identifying alphanumeric characters includes applying an object character recognition process to the pixels of the region of interest.

4. The method for managing an image of claim 3 further comprising detecting the user selecting a color of the alphanumeric characters and modifying the object character recognition process to identify the alphanumeric characters based on the color of the alphanumeric characters.

5. The method for managing an image of claim 3 further comprising applying a fill detection process to the region of interest to identify a location of the alphanumeric characters and boundaries of the alphanumeric characters.

6. The method for managing an image of claim 1 further comprising displaying the alphanumeric characters as a layer overlapping the image.

7. A device comprising:
a display component to display an image;
a sensor to detect a user accessing a region of interest of the image; and
a controller to access pixels of the region of interest to identify alphanumeric characters within the region of interest and store the alphanumeric characters and a location of the alphanumeric characters within metadata of the image.

8. The device of claim 7 wherein the sensor detects for at least one of a finger and a pointing device touching the image displayed on the display component if detecting the user accessing the region of interest of the image.

9. The device of claim 7 further comprising a storage component to store the image and the metadata of the image.

10. The device of claim 7 further comprising an image capture component to capture the image.

11. The device of claim 10 further comprising an input component to detect the user modifying the metadata of the image.

12. A computer readable medium comprising instructions that if executed cause a controller to:
detect a user accessing a region of interest of an image with a sensor;
access pixels of the image corresponding to the region of interest to identify alphanumeric characters within the region of interest; and
store the alphanumeric characters and a location of the alphanumeric characters within metadata of the image.

13. The computer readable medium comprising instructions of claim 12 wherein the sensor detects the user modifying at least one of a dimension of the region of interest and a size of the region of interest.

14. The computer readable medium comprising instructions of claim 13 wherein the controller detects the user modifying the alphanumeric characters stored on the metadata.

15. The computer readable medium comprising instructions of claim 13 wherein the controller detects the user modifying the location of the alphanumeric characters stored on the metadata.
